(19) United States
(12) Patent Application Publication
(10) Pub. No.: US 2016/0232501 A1
(43) Pub. Date: Aug. 11, 2016

(54) Bulk Payments System and Method

(71) Applicant: MasterCard International Incorporated, Purchase, NY (US)

(72) Inventors: Kenny Unser, Fairfield, CT (US); Harrison Siegel, White Plains, NY (US)

(21) Appl. No.: 14/617,726

(22) Filed: Feb. 9, 2015

(51) Int. Cl. G06Q 20/10; G06Q 20/40; G06Q 30/04

(52) U.S. Cl. CPC G06Q 20/102; G06Q 30/04; G06Q 20/4016

(57) ABSTRACT

A system, method, and computer-readable storage medium configured to reduce the computational burden of commercial enterprises supplying bulk payment fees.

### BACKGROUND

1. Field of the Disclosure

Aspects of the disclosure relate in general to commercial services. Aspects include a method and analysis platform to reduce the computational burden of commercial enterprises to support bulk sale pricing.

2. Description of the Related Art

A payment card is a card that can be used by an accountholder and accepted by a merchant to make a payment for a purchase or in payment of some other obligation. Payment cards include credit cards, debit cards, charge cards, and Automated Teller Machine (ATM) cards. Payment cards provide the clients of a financial institution (“accountholders”) with the ability to pay for goods and services without the inconvenience of using cash.

In a different art, many commercial enterprises offer discount for bulk purchases. These include everything from a “buy one get one free” promotion to transactions that involve thousands or even millions of units. There is also administrative cost to supporting bulk sale pricing.

### SUMMARY

Embodiments include a system, device, method and computer-readable medium to reduce the computational burden of commercial enterprises supporting bulk purchase discounts.

The system includes a processor and a network interface. A network interface is configured to receive transaction data from an acquirer. The transaction data describes the payment transaction and includes: an account identifier associated with the accountholder, a merchant identifier, an amount of the transaction and for each bulk-purchase-eligible item purchased: a number of units purchased and a bulk purchase indicator. A processor is configured to match the merchant identifier and the bulk purchase indicator with a bulk payment rule in a database. The bulk payment rule includes billing scale requirements and a billing scale. The processor matches the account identifier with an accountholder entry in a database. The accountholder entry includes accountholder data. The processor determines whether the accountholder qualifies for bulk purchase pricing based at least in part on the billing scale requirements and the accountholder data, and calculates a suggested bill amount based on the bulk payment rule when the accountholder qualifies for bulk purchase pricing. The network interface is further configured to transmit to the acquirer the suggested bill amount when the accountholder qualifies for bulk purchase pricing.

### BRIEF DESCRIPTION OF THE DRAWINGS

FIG. 1 is a block diagram illustrating a payment network to reduce the computational burden of commercial enterprises supporting bulk purchase discount fees.

FIG. 2 is an expanded block diagram of an exemplary embodiment of a server architecture of a payment network embodiment configured to reduce the computational burden of commercial enterprises supporting bulk purchase discount fees.

FIGS. 3A-B illustrate a real time authorization process, from the perspective of a payment network, to reduce the computational burden of commercial enterprises supporting bulk purchase discount fees.

### DETAILED DESCRIPTION

One aspect of the disclosure includes the realization that the information gathering and tracking of bulk purchase payments is burdensome and inefficient. Additionally, as many merchants or vendors provide such bulk payments, the process is repeated by each organization offering such a payment program. The repeated collection of the same or similar information by each party is onerous on the customer/purchaser. A bulk purchase pricing program is a program in which pricing of products or services vary when multiple units are purchased. For example, in one program the first thousand units are charged a first price per unit, and the next thousand units are charged another different price per unit.

Another aspect of the disclosure is the understanding that a central location can be used to collect accountholder data, unit purchase data, and assess the accountholder's participation in a bulk payment program. For example, the central location can be used to determine the total number of units purchased by an accountholder over any given period of time.

Aspects of the disclosure include a method and system of making bulk fee assessments and allowing merchants to determine payments owed by each accountholder in a more efficient manner.

While embodiments described herein are applied to a payment network and point-of-sale context, it is understood by those familiar with the art that the concepts, apparatus, system and methods described herein may also be applicable to an issuer and point-of-sale context.

The systems and processes are not limited to the specific embodiments described herein. In addition, components of each system and each process can be practiced independently and separately from other components and processes described herein. Each component and process also can be used in combination with other assembly packages and processes.

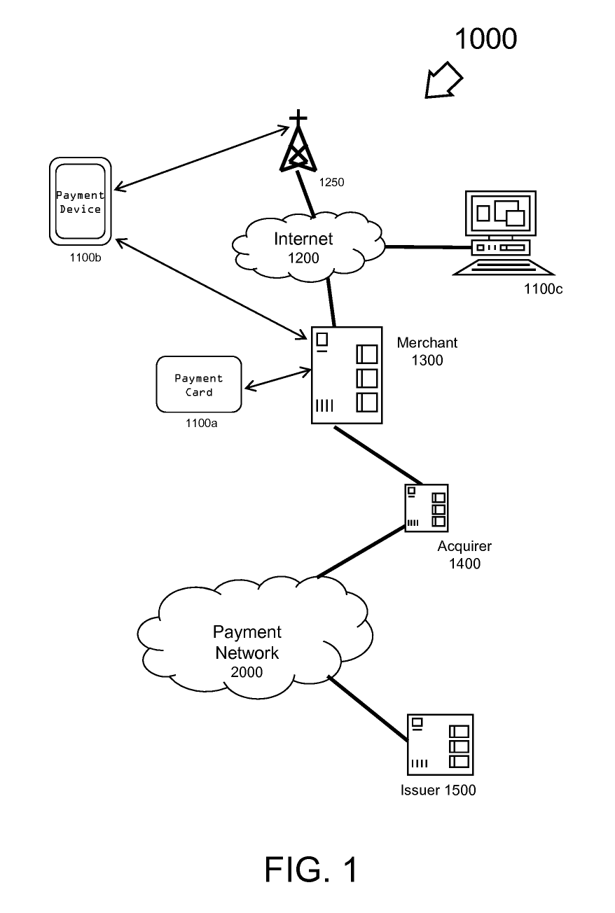

FIG. 1 is a block diagram 1000 illustrating a system and method of making bulk fee assessments and allowing merchants to determine payments owed by each accountholder in a more efficient manner. The present disclosure is related to a payment network, such as a credit card payment system using a payment network 2000, such as the MasterCard® interchange, Cirrus® network, or Maestro®. The MasterCard interchange is a proprietary communications standard promulgated by MasterCard International Incorporated of Purchase, N.Y., for the exchange of financial transaction data between financial institutions that are customers of MasterCard International Incorporated. Cirrus is a worldwide interbank network operated by MasterCard International Incorporated linking debit and payment devices to a network of ATMs throughout the world. Maestro is a multi-national debit card service owned by MasterCard International Incorporated.

In a financial payment system, a financial institution called the “issuer” 1500 issues a payment account to a consumer, who uses payment device 1100a-c to tender payment for a bulk purchase from merchant 1300. Payment devices may include a payment card 1100a, mobile device 1100b (such as key fobs, mobile phones, tablet computers, Personal Digital Assistants (PDAs), electronic wallets and the like), or computers 1100c. Payment devices may be used to tender purchase in-person at merchant 1300, or when connected via a mobile telephone network 1250 or the internet 1200.

In this example, a user makes a purchase at merchant 1300; the sale may include goods or services that are subject to a bulk pricing system. User presents the payment device 1100 to a point-of-sale device at merchant 1300. The merchant 1300 is affiliated with a financial institution. This financial institution is usually called the “acquiring bank” “acquirer bank,” or “acquirer” 1400. The acquirer 1400 may be a merchant bank or a payment service provider (PSP). When a payment device 1100 is tendered at merchant 1300, the merchant 1300 electronically requests authorization from the acquirer 1400 for the amount of the purchase. The authorization request includes an indicator or indicators that certain goods or services are subject to the bulk pricing system, and the number of units purchased. The indicators may directly relate to the goods and services. The request is performed electronically with the consumer's account information. For payment cards, the consumer's account information may be retrieved from the magnetic stripe on a payment card 1100a or via a computer chip imbedded within the payment card 1100a. For other types of payment devices 1100b-c, the consumer's account information may be retrieved by wireless methods, such as contactless communication like MasterPass® or via Near Field Communication (NFC). The account information, along with the bulk pricing indicator and number of units purchased, is forwarded to transaction processing computers of the acquirer 1400. Alternatively, an acquirer 1400 may authorize a third party to perform transaction processing on its behalf. In this case, the merchant 1300 will be configured to communicate with the third party. Such a third party is usually called a “merchant processor” or an “acquiring processor” (not shown).

The computers of the acquirer 1400 or the merchant processor will communicate, via payment network 2000, with the computers of the issuer bank 1500 to determine whether the consumer's account is in good standing and whether the accountholder qualifies for bulk purchase pricing. It is understood that any number of issuers 1500 may be connected to payment network 2000.

Based on the bulk pricing indicator, number of units purchased, and the consumer's account information, the payment network 2000 or issuer 1500 retrieves accountholder data to determine whether the consumer qualifies for the bulk pricing. For example, suppose the merchant has a bulk purchase agreement with the accountholder: for the first thousand units the accountholder is charged $10/unit; for each additional unit purchased the accountholder is charged $9/unit. When the consumer qualifies for the bulk pricing, the payment network 2000 or issuer 1500 recalculates the amount owed on the transaction based on the bulk, presenting the proposed recalculated amount to the merchant 1300. The merchant can then either adopt or reject the proposed recalculated amount for the transaction.

After a transaction is captured, a clearing process occurs.

Eventually, the transaction is settled between the merchant 1300, the acquirer 1400, and the issuer 1500.

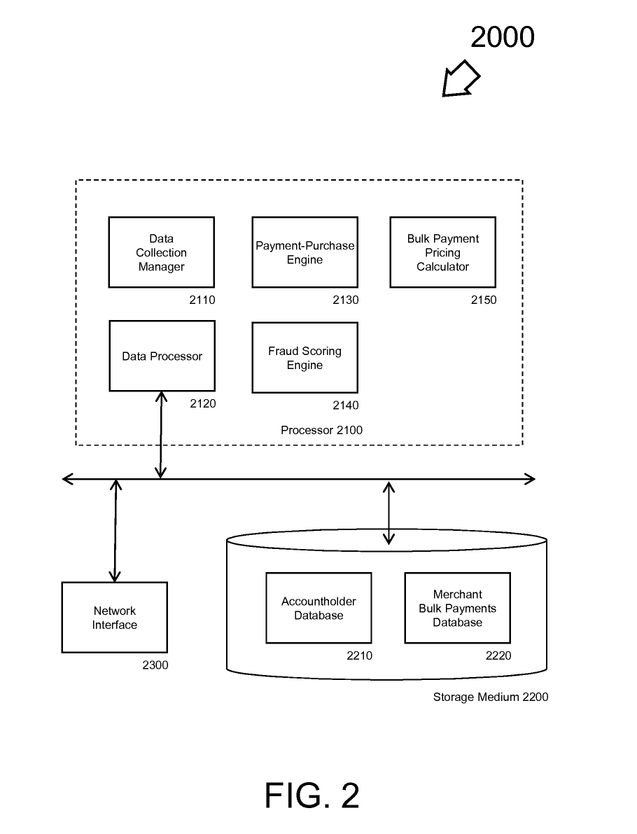

Embodiments will now be disclosed with reference to a block diagram of an exemplary payment network server 2000 of FIG. 2, configured to make bulk fee assessments and allowing merchants to determine payments owed by each accountholder, constructed and operative in accordance with an embodiment of the present disclosure. While payment network server is described as being part of payment network 2000, it is understood that in some embodiments the payment network server described herein could be located at an issuer 1500.

Payment network server 2000 may run a multi-tasking operating system (OS) and include at least one processor or central processing unit (CPU) 2100, a non-transitory computer-readable storage medium 2200, and a network interface 2300.

Processor 2100 may be any central processing unit, microprocessor, micro-controller, computational device or circuit known in the art. It is understood that processor 2100 may temporarily store data and instructions in a Random Access Memory (RAM) (not shown), as is known in the art.

As shown in FIG. 2, processor 2100 is functionally comprised of a data collection manager 2110, a payment-purchase engine 2130, a data processor 2120, a fraud scoring engine 2140, and a bulk payment pricing calculator 2150.

Data processor 2120 interfaces with storage medium 2200 and network interface 2300. The data processor 2120 enables processor 2100 to locate data on, read data from, and writes data to, these components.

Payment-purchase engine 2130 performs payment and purchase transactions, and may do so in conjunction with data collection manager 2110 and bulk payment pricing calculator 2150.

Data collection manager 2110 is the structure that facilitates input of bulk accountholder information. The bulk accountholder information is supplied by the accountholder when they opt-into a bulk pricing program. In some embodiments, the data collection manager 2110 is a World-Wide-Web interface that allows the accountholder to load information into the accountholder database 2210. In other embodiments where the accountholder has supplied bulk accountholder information to merchant 1300, data collection manager 2110 may receive the information directly from merchant 1300.

In some embodiments, data collection manager 2110 may include telephone support, mail processing, or receive third party data extracts stored locally.

Bulk accountholder information may include, but is not limited to:

Data material to tracking bulk payments;

Data material to implementing discounts;

Data related to multiple product/service brands and/or locations;

Purchase Frequency, such as the number of purchases over a certain dollar amount, or number of units purchased;

Purchase Amount, such as the total spend above a certain dollar amount, or category expenditures above a dollar amount;

Qualifying Purchases, for example purchase of a new sailboat results in an accountholder being qualified for 10% off sailboat accessories;

Card Continuity to track discount eligibility across multiple payment accounts when the accountholder bulk payment profile is associated with multiple payment accounts;

Card continuity within a family or corporate entity, to track discount eligibility across multiple accountholders when the accountholder bulk payment profile is associated with multiple payment accounts.

In some embodiments, data collection manager 2110 may include telephone support, mail processing, or receive third party data extracts stored locally at accountholder database 2210.

Bulk payment pricing calculator 2150 is configured to apply merchant bulk rules (also referred to as a “bulk payment rule”), which are saved in a merchant bulk payments database 2220, to determine whether an accountholder qualifies for bulk pricing, and how many units have already been purchased. A bulk payment rule may include qualification or quantity requirements and pricing information. The qualification or quantity requirements determine the qualifications for the pricing information. When the accountholder qualifies for bulk pricing, the bulk payment pricing calculator 2150 recalculates the amount owed on the transaction based on the bulk purchase and the amount of widgets already purchased, presenting the proposed recalculated amount to the merchant 1300. The merchant 1300 can then either adopt or reject the proposed recalculated amount for the transaction.

Merchant bulk rules may be collected from merchant 1300 on a periodic basis, and may include, but is not limited to:

Data and/or algorithms used to apply bulk discounts, including algorithms used to calculate bulk discounts;

Total Purchase Frequency;

Total Purchase Amount;

Specific Item Purchase Frequency;

Specific Item Purchase Amount;

Qualifying purchase(s); and,

Pricing data.

Information about applying bulk pricing may include, but is not limited to:

Unit Thresholds;

Spend Thresholds;

Qualifying purchases, for example, if an accountholder pays for a room at a hotel the night before their flight, they can pay a discounted rate for airport parking with an affiliated parking garage; or if an accountholder buys a threshold amount in a certain time period, they receive a discount during a subsequent time period or purchase.

These structures may be implemented as hardware, firmware, or software encoded on a computer readable medium, such as storage medium 2200. Further details of these components are described with their relation to method embodiments below.

Computer-readable storage medium 2200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. In some embodiments, computer-readable storage medium 2200 may be remotely located from processor 2100, and be connected to processor 2100 via a network such as a local area network (LAN), a wide area network (WAN), or the Internet.

In addition, as shown in FIG. 2, storage medium 2200 may also contain an accountholder database 2210 and a merchant bulk payments database 2220. Accountholder database 2210 contains information about an accountholder, including payment accounts (and their Primary Account Numbers) associated with an accountholder, an account transaction history, and any information collected by the data collection manager 2110. Merchant bulk payments database 2220 is configured to store merchant bulk rules, which define the conditions and requirements for a bulk pricing at a merchant 1300. Merchant bulk rules are provided by merchant 1300 when the merchant decides to allow bulk pricing assessments to be made by payment network server 2000.

Network interface 2300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 2300 allows payment network server 2000 to communicate with acquirer 1400 and issuer 1500.

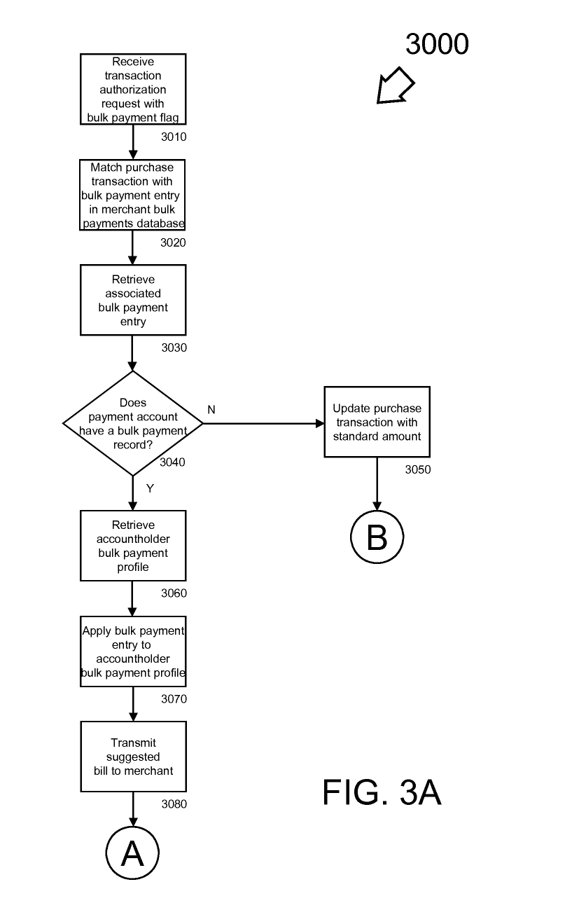

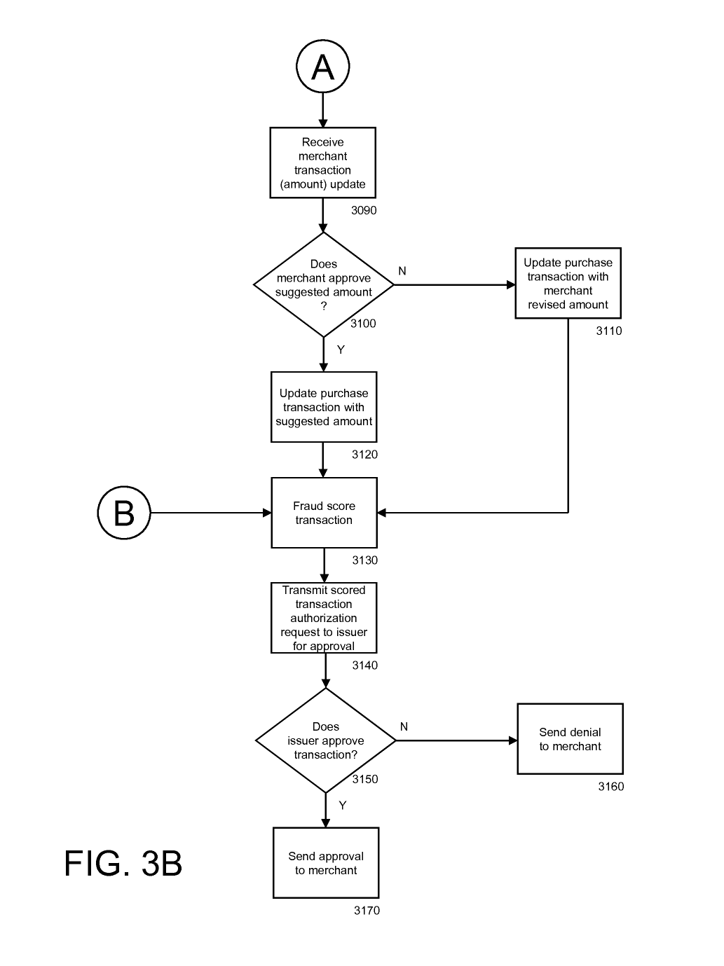

We now turn our attention to a method or process embodiment of the present disclosure, FIGS. 3A-3B. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 3 illustrates a process 3000, from the perspective of a payment network server 2000, to reduce the computational burden of commercial enterprises supplying bulk discount fees, constructed and operative in accordance with an embodiment of the present disclosure. It is understood by those familiar with the art that process 3000 is a real-time authentication process.

At block 3010, payment network 2000 receives a transaction authorization request from an acquirer 1400. The transaction authorization request is received electronically via a network interface 2300, and contains transaction data including: an account identifier for a payment account (which can be a Primary Account Number), a merchant identifier, an amount of the transaction, a transaction type (purchase, return, cash-advance, and the like). For each product or service that qualifies for bulk purchase pricing, the transaction data includes the number of units purchased and a bulk identifier. The bulk identifier identifies the item or items in the transaction that may be subject to a bulk payment. Suppose, for example, the merchant offers widgets for sale in a bulk payment program. In this case, the number of widgets being purchased and a bulk identifier, while non-bulk purchase items are not marked.

Payment-purchase engine 2130 matches the transaction authorization request with a bulk payment rule in the merchant bulk payments database 2220, block 3020. Generally, the combination of the merchant identifier and bulk identifier of the transaction authorization request is used for the matching.

At block 3030, the bulk payment pricing calculator 2150 retrieves the associated bulk payment rule from the merchant bulk payments database 2220.

At decision block 3040, the bulk payment pricing calculator 2150 determines whether the payment account (identified via the account identifier) has an associated accountholder bulk payment profile stored in the accountholder database 2210.

If the payment account does not have an accountholder bulk payment profile, as determined at decision block 3040, the accountholder automatically does not qualify for the bulk purchase pricing via process 3000, the purchase transaction is updated with the standard amount for the item, block 3050, and the authorization process 3000 continues at block 3130.

If the payment account has an accountholder bulk payment profile, as determined at decision block 3040, the process continues at block 3060.

At block 3060, the bulk payment pricing calculator 2150 retrieves the accountholder bulk payment profile profile.

The billing scale is applied to the accountholder bulk payment profile by the bulk payment pricing calculator 2150, block 3070. Bulk accountholder information is used to access the accountholder's qualification (number of items previously purchased, amount purchased, qualifying purchases, and the like) and calculate payment (pricing tiers, fee algorithms and the like) under the bulk pricing program. Algorithms provided by the merchant 1300 are applied to determine the cost of the bulk payment priced goods and services, resulting in a revised suggested bill amount.

The suggested bill amount is transmitted to merchant 1300 by network interface 2300 for approval, block 3080. In some embodiments, the transmitted suggested bill also includes an indication about the bulk payment rule that caused the suggested change.

At this point, the merchant 1300, can either adopt the suggested bill amount or revise the transaction amount in a merchant transaction amount update. At block 3090, network interface 2300 receives the merchant transaction amount update. In some embodiments, the merchant transaction amount update may be a new (or same) amount specified for the transaction. In other embodiments, the merchant transaction amount update may be an identifier signifying whether the suggested bill amount or original bill amount should be adopted.

When the merchant decides to override the suggested bill amount, as determined at decision block 3100, the purchase transaction is updated with the merchant revised amount, block 3110, and the process continues at block 3130.

When the merchant declines to override the suggested bill amount, as determined at decision block 3100, the purchase transaction is updated with the suggested bill amount, block 3120, and the process continues at block 3130.

At block 3130, fraud scoring engine 2140 fraud scores the transaction using the applicable bill amount. Fraud scoring refers to an indication, or likelihood, that a payment transaction is fraudulent. In one embodiment, the fraud scoring engine 2140 provides a number back to the payment card issuer between zero and 1,000, which translates into zero and 100 percent, in tenths of percentage points. The fraud-scoring is based at least in part on the transaction authorization request and prior spending behavior as derived from the accountholder database 2210.

Payment network 2000 transmits the scored transaction authorization request to issuer 1500 for approval, block 3140. The authorization transaction message including the type of transaction, a merchant identifier, the amount of transaction, and an account identifier; the account identifier may be a Primary Account Number or other representation of an account.

Depending upon the issuer 1500 approval of the transaction, as determined at decision block 3150, an approval message is sent to merchant 1300, block 3170, or a decline message is sent, block 3160.

### Use Examples

It is understood that the system described herein may be applied to a variety of different applications. This section describes some of the possible applications.

In some embodiments, bulk pricing qualifications may be made by a combination of minimum number of purchases and minimum amount. For example, an accountholder may be eligible for a $25 discount at a chain of restaurants after making 10 purchases for over $25.

In another embodiment, bulk pricing qualification may be made by identification of business accounts. For example, all business payment accounts associated with a company receive a 10% discount at a hardware store merchant.

In an alternate embodiment, a merchant gives a free item or service once a minimum number are purchased. For example, a hairdresser may offer a free haircut after six haircuts are purchased across all payment card accounts or payment accounts held by family members.

In yet another embodiment, a merchant may provide a free item or service once a minimum number of transactions have occurred (a transaction threshold). For example, a grocery store may offer for a free Thanksgiving turkey if a cardholder makes twenty visits to the store during the period of January to November. If the accountholder meets the transaction threshold, the cost of the turkey is deducted from the transaction cost.

In another embodiment, a merchant may provide a discount based on spending thresholds. For example, once an accountholder spends $1,000 at a home improvement center in a 12 month period, their future purchases receive a 10% discount.

In yet another embodiment, a merchant may provide discounts based on the number of units purchased. For example, an auto part retailer offers discounts on oil as follows: 0-10 liters @ full price, 11-20 liters @ 90% of list price, and 21+ liters @ 80% of list price. Purchases can be spread across multiple transactions in any calendar year.

It is understood by those familiar with the art that the system described herein may be implemented in hardware, firmware, or software encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. A real-time method to process a payment transaction, the method comprising:
receiving, with a network interface, transaction data from an acquirer, the transaction data describing the payment transaction and including: an account identifier associated with the accountholder, a merchant identifier, an amount of the transaction and for each bulk-purchase-eligible item purchased: a number of units purchased and a bulk purchase indicator;
matching, with a processor, the merchant identifier and the bulk purchase indicator with a bulk payment rule in a database, the bulk payment rule including billing scale requirements and a billing scale;
matching, with a processor, the account identifier with an accountholder entry in a database, the accountholder entry including accountholder data;
determining, with the processor, whether the accountholder qualifies for bulk purchase pricing based at least in part on the billing scale requirements and the accountholder data;
calculating, with the processor, a suggested bill amount based on the bulk payment rule when the accountholder qualifies for bulk purchase pricing;
transmitting to the acquirer, with the network interface, the suggested bill amount when the accountholder qualifies for bulk purchase pricing.

2. The processing method of claim 1, wherein the billing scale includes percentage discounts, or hourly rates.

3. The processing method of claim 2, wherein the billing scale requirements include number of items purchased, amount purchased or qualifying purchases.

4. The processing method of claim 3, wherein the accountholder data includes number of purchases, amount purchased, or association qualifications.

5. The processing method of claim 4, further comprising:
receiving, with the network interface, a merchant transaction amount update;
updating the amount of the transaction with the merchant transaction amount update with the processor;
fraud scoring the payment transaction based at least in part on the transaction data and the accountholder entry, resulting in a fraud score; and,
transmitting, with the network interface, to an issuer of the account identifier: the transaction data and the fraud score.

6. A real-time system to process a payment transaction, the system comprising:
a network interface configured to receive transaction data from an acquirer, the transaction data describing the payment transaction and including: an account identifier associated with the accountholder, a merchant identifier, an amount of the transaction and for each bulk-purchase-eligible item purchased: a number of units purchased and a bulk purchase indicator;
a processor configured to match the merchant identifier and the bulk purchase indicator with a bulk payment rule in a database, the bulk payment rule including billing scale requirements and a billing scale, to match the account identifier with an accountholder entry in a database, the accountholder entry including accountholder data, to determine whether the accountholder qualifies for bulk purchase pricing based at least in part on the billing scale requirements and the accountholder data, and to calculate a suggested bill amount based on the bulk payment rule when the accountholder qualifies for bulk purchase pricing; and,
the network interface is further configured to transmit to the acquirer the suggested bill amount when the accountholder qualifies for bulk purchase pricing.

7. The processing system of claim 6, wherein the billing scale includes percentage discounts or hourly rates.

8. The processing system of claim 7, wherein the billing scale requirements include number of items purchased, amount purchased or qualifying purchases.

9. The processing system of claim 8, wherein the accountholder data includes number of purchases, amount purchased, or association qualifications.

10. The processing system of claim 9, wherein:
the network interface is further configured to receive a merchant transaction amount update;
the processor is further configured to update the amount of the transaction with the merchant transaction amount update, to fraud score the payment transaction based at least in part on the transaction data and the accountholder entry, resulting in a fraud score; and,
the network interface is further configured to transmit to an issuer of the account identifier: the transaction data and the fraud score.

11. A non-transitory computer-readable medium encoded with data and instructions, when executed by a computing device the instructions cause the computing device to:
receive, with a network interface, transaction data from an acquirer, the transaction data describing the payment transaction and including: an account identifier associated with the accountholder, a merchant identifier, an amount of the transaction and for each bulk-purchase-eligible item purchased: a number of units purchased and a bulk purchase indicator;
match, with a processor, the merchant identifier and the bulk purchase indicator with a bulk payment rule in a database, the bulk payment rule including billing scale requirements and a billing scale;
match, with a processor, the account identifier with an accountholder entry in a database, the accountholder entry including accountholder data;
determine, with the processor, whether the accountholder qualifies for bulk purchase pricing based at least in part on the billing scale requirements and the accountholder data;
calculate, with the processor, a suggested bill amount based on the bulk payment rule when the accountholder qualifies for bulk purchase pricing;
transmit to the acquirer, with the network interface, the suggested bill amount when the accountholder qualifies for bulk purchase pricing.

12. The computer-readable medium of claim 11, wherein the billing scale includes percentage discounts or hourly rates.

13. The computer-readable medium of claim 12, wherein the billing scale requirements include number of items purchased, amount purchased or qualifying purchases.

14. The computer-readable medium of claim 13, wherein the accountholder data includes number of purchases, amount purchased, or association qualifications.

15. The computer-readable medium of claim 14, wherein the instructions further cause the computing device to:
receive, with the network interface, a merchant transaction amount update;
update the amount of the transaction with the merchant transaction amount update with the processor;
fraud score the payment transaction based at least in part on the transaction data and the accountholder entry, resulting in a fraud score; and,
transmit, with the network interface, to an issuer of the account identifier: the transaction data and the fraud score.
